(19) United States
(12) Patent Application Publication
(10) Pub. No.: US 2017/0209783 A1
(43) Pub. Date: Jul. 27, 2017

(54) SCRATCH-OFF GAMES WITH COLLECTIBLE VARIABLE REVEAL FEATURE

(71) Applicant: Hydra Management LLC, New York, NY (US)

(72) Inventors: Fred W. FINNERTY, Dawsonville, GA (US); Kenneth E. IRWIN, JR., Dawsonville, GA (US)

(21) Appl. No.: 15/244,170

(22) Filed: Aug. 23, 2016

Related U.S. Application Data
(60) Provisional application No. 62/281,811, filed on Jan. 22, 2016.

(51) Int. Cl. A63F 3/06; B42D 25/27

(52) U.S. Cl. CPC A63F 3/0665; A63F 3/0655; B42D 25/27

(57) ABSTRACT

A security-enhanced document with collectible imaging, the document includes a substrate; at least one lower portion imaging with graphic imaging and with or without first variable indicia, the lower portion imaging directly or indirectly digitally imaged on the substrate, the lower portion comprising first collectible digital imaging; at least one release coat applied over the first collectible imaging; at least one scratch-off-coating layer applied over the release coat to maintain the first collectible imaging of the lower portion unreadable until removal of the scratch-off-coating; and at least one overprint upper portion with or without second variable indicia and with second collectible digital imaging associated with the lower portion first collectible imaging with respect to a visual or thematic aspect of the first collectible imaging. The document enhances the popularity and fun games using the document, and may expand the consumer base for the games.

### CROSS-REFERENCE TO RELATED APPLICATION

This application claims the benefit of U.S. Patent Application No. 62/281,811, filed Jan. 22, 2016, the disclosure of which is hereby incorporated herein by reference in its entirety.

### FIELD OF THE INVENTION

The present invention relates generally to instant (scratch-off) games, such as lottery tickets, having indicia under a Scratch-Off-Coating (SOC), and more particularly to methods for enhancing play value of the instant games while also adding to the aesthetics.

### BACKGROUND

Lottery games have become a time honored method of raising revenue for state and federal governments the world over. Traditional scratch-off and draw games have evolved over decades, supplying increasing revenue year after year. However, after decades of growth, the sales curves associated with traditional games seem to be flattening out. This flattening of lottery sales curves is typically attributed to a fixed base of consumers that routinely purchase lottery products with very few new consumers choosing to participate in the lottery marketplace. Various analyses of state lottery sales data tend to support the hypothesis that lotteries rely heavily on an existing consumer base and more specifically on lottery “super users.” Three states (Rhode Island, South Dakota and Massachusetts) had 2014 lottery sales that topped $700 per capita. While ten states had per capita sales below $100, per capita sales for all state lotteries averaged almost $250. Demographically speaking, this existing base of lottery consumers is aging with younger consumers showing very little interest in participating in existing lottery offerings. Thus, the potential for ever-increasing lottery sales is increasingly problematic with the existing fixed base of consumers saturated. Consequently, both lotteries and their service providers are presently searching for new forms of gaming.

In addition to flattening sales, a static lottery consumer base is often cited as exploiting problem gamblers with various legislatures debating restrictions or probations being placed on lotteries. For example, “Stop Predatory Gambling”, which advocates an end to state-sponsored gambling recently stated: “State lotteries have a business model that's based on getting up to 70 to 80 percent of their revenue from 10 percent of the people that use the lottery . . . .” In Minnesota, a pending bipartisan bill would require 25% of lottery billboards to be dedicated to a warning about the odds of winning, cautions about addiction, and information on where problem gamblers can seek help.

In an attempt to diversify their base and increase sales, United States Lotteries have come to appreciate the virtues of producing games with more entertainment value that can be sold at a premium price. For instance, ten-dollar instant ticket games with higher paybacks and more ways to win now account for over $5 billion a year in United States lottery sales. But by their nature, high-volume, generic, higher priced instant games with higher prizes are a minor part of overall game offerings and although they have their place, they have limited potential for assisting in consumer base diversification. Additionally, these higher priced and high-volume games also typically add little unique entertainment value relative to lower priced instant tickets and consequently do not to attract many new consumers.

Another attempt of United States lotteries to diversify their base and increase sales has been printing collector instant ticket games where the display portion of the instant ticket is reserved for collector specific imaging—e.g., various images from the television and movie series “Star Trek”. However, these collector tickets had the unforeseen disadvantage of inadvertently encouraging consumers to attempt to “cherry pick” certain tickets to complete their collections, that is buy only tickets with the desired collector images. This “cherry picking” process required the retailer to pull requested tickets from the middle of a sequential chain at the consumer's request, resulting in a corresponding increase in labor that made collector series of lottery tickets unpopular with retailers. Thus, while these limited collector instant ticket series did potentially attract new customers to the lottery, overall sales remained flat at best due to retailer's refusal to carry collector series games.

It is highly desirable to develop gaming systems methodologies that provide methods of playing new gaming opportunities, particularly more customized and consequently smaller volume games. Ideally these gaming methodologies should allow for flexibility and creativity for game designers to tailor games to a wide variety of small targeted segments previously not served by existing gaming offerings thereby appealing to a broader base of consumers.

### SUMMARY OF THE INVENTION

Objects and advantages of the invention will be set forth in part in the following description, or may be apparent from the description, or may be learned through practice of the invention.

One aspect of the invention relates to a security-enhanced document with collectible imaging, the document comprising: a substrate; at least one lower portion imaging with graphic imaging and with or without first variable indicia, the lower portion imaging directly or indirectly digitally imaged on the substrate, the lower portion comprising first collectible digital imaging; at least one release coat applied over the first collectible imaging; at least one SOC layer applied over the release coat to maintain the first collectible imaging of the lower portion unreadable until removal of the SOC; and at least one overprint upper portion with or without second variable indicia and with second collectible digital imaging associated with the lower portion first collectible imaging with respect to a visual or thematic aspect of the first collectible imaging.

A second aspect of the invention relates to the document as in the first aspect, wherein the imaging of the upper and lower portions is comprised of process colors.

A third aspect of the invention relates to the document as in the first aspect, wherein the imaging of the upper and lower portions is comprised of digitally imaged spot colors.

A fourth aspect of the invention relates to the document as in the first aspect, wherein at least a part of the lower portion imaging comprises a coupon.

A fifth aspect of the invention relates to the document as in the first aspect, wherein the document is a scratch-off game piece, and wherein the lower portion imaging includes the first variable indicia, the first variable indicia comprising one or more win or lose gaming imaging representing game play, the release coat, SOC and the overprint applied over both the first collectible imaging and the gaming imaging.

A sixth aspect of the invention relates to the document as in the fifth aspect, wherein areas of the document containing the gaming imaging and the second collectible imaging are separable by a perforation or indention in the document.

A seventh aspect of the invention relates to the document as in the fifth aspect, wherein the document optionally includes variable logistical information on a back surface of the document optionally required for validation and redemption of a winning game piece.

An eighth aspect of the invention relates to the document as in the fifth aspect, wherein the collectible imaging is independent of the game play.

A ninth aspect of the invention relates to the document as in the fifth aspect, wherein the collectible imaging is a part of the game play.

A tenth aspect of the invention relates to the document as in the fifth aspect, wherein the lower portion variable imaging may have matching indicia that represent a value comprising a prize, such that matching indicia of the lower portion represent a game win of the prize pursuant to game rules in the game play.

In accordance with the above and other aspects of the invention, secure documents, such as instant games, are created using variable imaging below and above the SOC. The variable imaging below the SOC is referred to in various instances in this description and claims as the at least one lower portion imaging with graphic imaging and with or without first variable indicia, the lower portion imaging being directly or indirectly digitally imaged on the substrate, with the understanding that the lower portion imaging also includes first collectible imaging. Sometimes the variable imaging below the SOC is referred to in shorthand as the lower portion imaging or just the lower portion. The variable imaging above the SOC is referred to in various instances in this description and claims as at least one overprint upper portion with or without second variable indicia and with second collectible digital imaging associated with the lower portion first collectible imaging with respect to a visual or thematic aspect of the first collectible imaging, or just the overprint upper portion, or just the overprint. By virtue of the overprint upper portion being registered to cover at least a part of the imaging of the lower portion, a transitional reveal of the lower portion variable indicia occurs as the SOC is gradually removed, and optionally also with the overprint upper portion second collectible imaging being gradually removed. In this way, the first collectible imaging of the lower portion gradually appears, so the customer can see if the first collectible imaging is one of the desired images of potentially many visually or thematically related images related to the second collectible image of the overprint of the upper portion. For example, the second collectible imaging of the overprint portion of a ticket may include the words or logo for “Star Trek” to generate interest for a potential purchaser to buy the ticket, hoping that the first collectible imaging will be revealed to show any number of characters, vehicles, scenes, or the like from any episodes associated with “Star Trek,” after removing the SOC. This transitional reveal can be for collecting purposes, amusing purposes or a strategic part of game play typically involving the first variable imaging, with matches, etc., according to the rules of the particular game or series of games.

In a first embodiment, the overprint upper portion imaging and the lower portion imaging is incorporated at least as part of the first collectible imaging portion in an amusing reveal display apart from the actual game play of an instant lottery ticket. The upper portion imaging, which can but need not cover all of the lower portion imaging, enables the non-gaming reveal of the lower portion imaging including the collectible imaging to differ from ticket to ticket, thereby creating variety and anticipation until the SOC is removed and the lower image is revealed. Thus, with this reveal feature tickets can be sold with hidden “Easter Eggs” (i.e., discoverable lower imaging unknown to the consumer) that only becomes apparent after the sale and the ticket is played. This non-gaming reveal display embodiment thereby adds value to the instant ticket gaming experience by adding an additional play element to the ticket that can vary over a very large range of tickets. Since the additional play element is independent of the gaming portion there is no impact on the prize fund associated with this feature.

In another embodiment, the upper portion imaging and the lower portion imaging reveal, especially the imaging including at least the first collectible imaging, are incorporated as part of the instant ticket's game play to either enhance the play experience or to enable different styles of play that heretofore were not possible with conventional fixed plate presses coupled with monochromatic low resolution (e.g., 240 dpi) digital imaging. This embodiment could also include an “Easter Egg” type reveal as disclosed above, only in this embodiment, the “Easter Egg” revealed would be associated with a prize. The essential difference between the two embodiments is whether the variable imaging reveal and collectible imaging are incorporated into game play (and consequently are part of the prize fund) or are included only as entertaining and collectible features that potentially increase the perceived value of the instant game without debiting the prize fund.

In another embodiment, the overprint upper portion with its second collectible imaging is associated with (sometimes referred to herein as “synchronized” with) the lower portion with its first collectible imaging, such that the upper portion has at least one associated feature imaged with respect to a visual or thematic aspect of the lower portion. As a result, by gradually removing the upper portion imaging and the SOC, the lower portion imaging is revealed, such that the upper portion imaging, with its second collectible imaging if desired, appears to dissolve visually or thematically into the first collectible imaging on the lower portion from the consumer's perspective. The principal advantage of this embodiment is the perceived enhanced value of the dissolve reveal. This is of particular interest where the upper portion imaging and the lower portion imaging are visually related, and especially when the dissolve and reveal concerns the second and first collectible imaging.

The variable imaging reveal is designed to hide potential first collector images under the SOC from consumers until after purchase. The concept of this hidden image reveal is to prevent “cherry picking” by consumers of unsold tickets in an attempt to secure the collectible image they desire without purchasing some tickets with differing images.

In all of these embodiments, the variable imaging reveal is incorporated with the use of at least two different color digital imagers—i.e., one digital imager for printing the reveal variable imaging hidden under the SOC until played and one digital imager for printing a variable image reveal on top of the SOC visible on unsold tickets. While it is theoretically possible to produce a type of instant ticket reveal using the traditional fixed plate printing techniques typically employed by lottery printers, the reveal mechanism would be severely limited in variety since the total number of variations would be limited to one cylinder (i.e., plate) rotation, which is typically between five to ten variations per rotation. With this invention of variable digital imaging reveals, the total number of variations becomes virtually unlimited thereby enabling multiple designs and game plays. Additionally, by incorporating high resolution color variable digital imaging reveal play, the distribution of key variable imaging and indicia can be extremely wide and consequently rare, thereby enhancing the perceived and/or actual value of any ticket with the key indicia.

Described is an example of any number of mechanisms and methodologies that provide practical details for reliably producing variable reveal imaging across multiple games. Although the example provided herein is primarily related to an instant lottery ticket, it is clear that the invention is applicable to any type of small number specialized games or other security-enhanced documents (e.g., American Legion Post drawing, telephone cards, activation cards, coupons, etc.) that include a SOC.

### BRIEF DESCRIPTION OF THE DRAWINGS

FIG. 1 is a top plan view of a representative example of a variable reveal game ticket involving collectible imaging where the collectible reveal feature is not part of the actual game play with its SOC intact.

FIG. 2 is a top plan view of the representative example of FIG. 1 with its SOC completely removed.

FIG. 3 is an exploded top front isometric schematic view of the representative example of FIG. 1 and FIG. 2 illustrating the positioning of the upper variable reveal overprint with an indication, in the form of the second collectible imaging, that the ticket includes the hidden variable first collectible imaging and the first variable indicia in the lower portion below the SOC, where the first collectible imaging is associated with the second collectible imaging indication.

FIG. 4 is a top plan view of the representative example of FIG. 1 and FIG. 2 with the upper variable reveal overprint and associated SOC partially removed.

FIG. 5 is a top plan view of the representative example of FIG. 4, with the addition of a perforation separating the second collectible imaging of the overprint upper portion at the top of the ticket from the gaming portion at the bottom of the ticket.

FIG. 6 is a top plan view of a second representative example of a variable reveal game where the reveal feature is not part of the actual game play with its SOC intact.

FIG. 7 is a top plan view of the first representative example of FIG. 6 with its SOC completely removed.

FIG. 8 is an exploded top front isometric schematic view of the representative examples of FIG. 6 and FIG. 7, illustrating the positioning of the upper variable reveal overprint feature second collectible imaging with respect to the lower variable reveal imaging with the first collectible imaging.

FIG. 9 is a top plan view of the representative examples of FIG. 6 and FIG. 7 with the upper variable reveal overprint and associated SOC partially removed, illustrating a “dissolve effect” of the visually associated first and second collectible imaging.

### DETAILED DESCRIPTION

Reference will now be made in detail to examples of the invention, one or more embodiments of which are illustrated in the drawings. Each example is provided by way of explanation of the invention, and not meant as a limitation of the invention. For instance, features illustrated or described as part of one embodiment may be used with another embodiment to yield still a further embodiment. It is intended that the present invention encompasses these and other modifications and variations as come within the scope and spirit of the invention.

In the context of this invention the term “variable imaging,” refers to methods of printing from a digital-based image directly to a variety of documents with a SOC (e.g., instant lottery ticket). Thus, as its name implies, “variable imaging” can vary from document-to-document and may include text, icons, drawings, photographs, etc. Any of the commercially available off-the-shelf digital printers (e.g., Memjet, Hewlett Packard—“HP”—Indigo, Xerox CiPress series, etc.) are capable of performing the “variable imaging” as described by this invention.

In some embodiments of the document in the form of a ticket, there are variable reveal features both in the lower portion imaging and the upper portion imaging that are not an integral part of instant game play dynamics. For example, it has long been a tradition for lottery tickets to motivate sales through display graphics. Variable imaging systems display art are capable of printing every ticket in a book of tickets as a unique graphic. While the ability to print every ticket in a pack differently lends itself to printing collector cards, the problem associated with collector cards would be consumers wanting a specific image and refusing to purchase a ticket unless the desired image is present. To solve this problem, the display art, namely the first collectible imaging of the lower portion imaging, can be printed below the SOC with a second more generic display graphic, namely the overprint upper portion imaging, without or preferably with the second collectible imaging associated with the first collectible imaging, printed on top of the SOC. In one example of this embodiment, books of tickets could be printed with images of players, cheerleaders, or a coach of a high school football team printed under the SOC, while the school's name and team mascot could or would be printed above the SOC. The generic graphic of the school's name and mascot would prompt people living in the school district to support their team and purchase tickets—e.g., parents and family members of those depicted on the tickets would be especially motivated to acquire tickets of their family member. Various team members or team supporters could be imaged as the first collectible image below the SOC and collected by those in a given community. Specific individual tickets could be acquired by trading tickets, group purchases such as team boosters, which would purchase an entire pack, then divide the pack between the pool of purchasers, Facebook trading pages, or individuals could purchase entire books of tickets as keepsakes of the team.

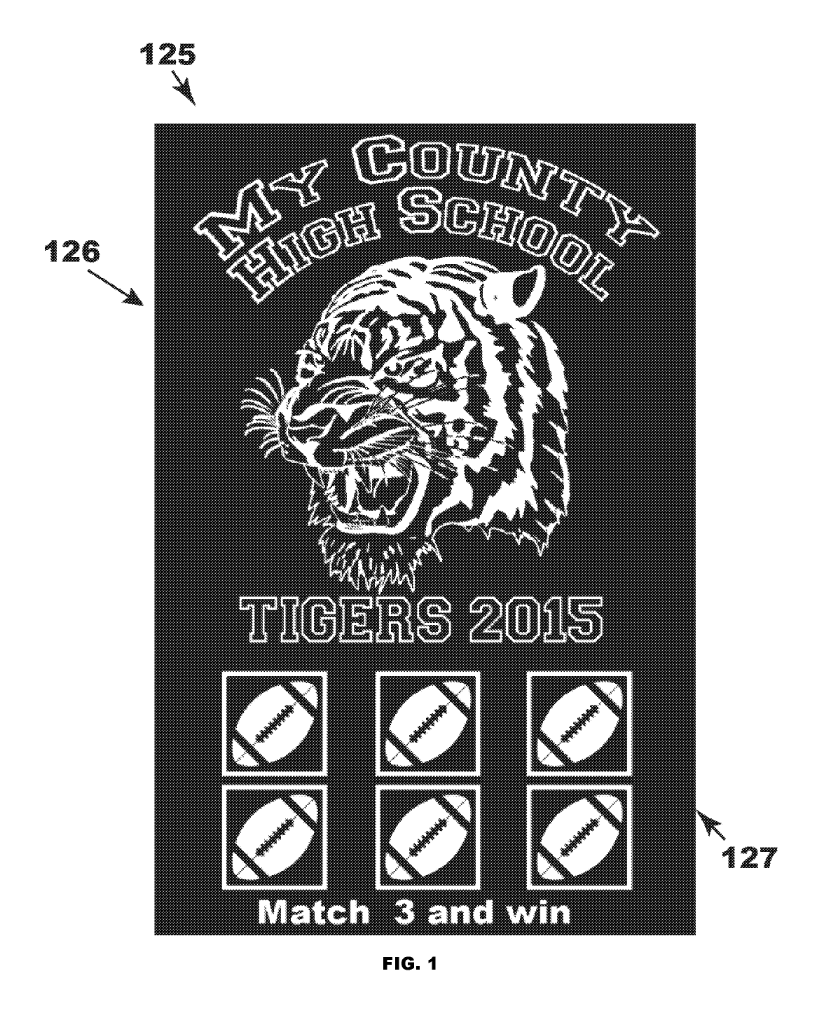

FIG. 1 is a top plan view illustration of one embodiment of an exemplary variable reveal game ticket 125 with its SOC intact according to this invention. As illustrated in embodiment of the ticket 125, the six “Match 3 and win” game play overprints 127 are a traditional instant ticket implementation where removal of the SOC simply discloses the game play indicia that are not necessarily related to the overprint image. However, the embodiment 125 also includes a variable reveal feature 126 that is not part of the actual game play in the form of the overprint upper portion imaging at the top part of the ticket, depicted in an exemplary manner as a school mascot logo and nickname with a particular team year.

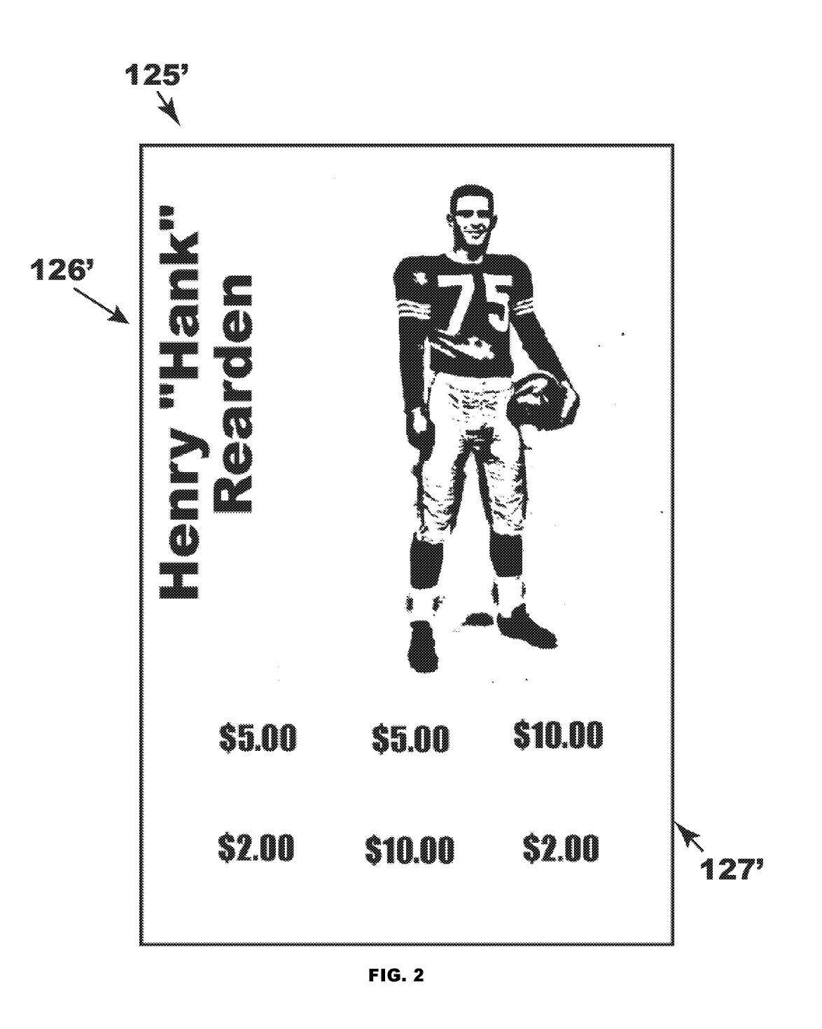

FIG. 2 illustrates the same exemplary top plan view of the ticket 125′ shown in FIG. 1 with all of its SOC removed, revealing the typical win or lose indicia 127′ of a standard instant ticket, as well as the variable reveal first collectible imaging 126′, in the form of a team member, with the team member's name, which is associated with the second collectible imaging of the second collectible imaging 126 of the overprint imaging of the upper portion in FIG. 1. This is an example of a thematic association, since the mascot image 126 of FIG. 1 is not visually related to the team member 126′ of FIG. 2 in the lower portion first collectible image (i.e., the played or scratched off rendition) of the ticket. Thus, the first collectible imaging 126′ is hidden from the consumer prior to purchasing the game. By hiding the collectible image 126′ under the SOC, consumers are prevented from “cherry picking” specific tickets from the lot on sale to purchase their desired collectible image.

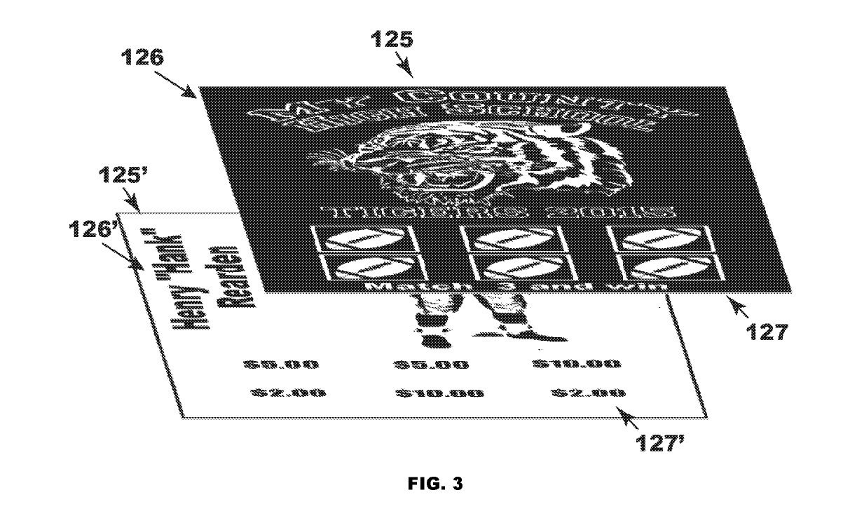

FIG. 3 is an exploded top front isometric schematic view of the representative example ticket of FIG. 1 and FIG. 2, illustrating the positioning of the upper variable reveal overprint with an indication, in the form of the second collectible imaging (namely the mascot 126) that the ticket includes the hidden variable first collectible imaging in the form of the team player 126′, with the first variable indicia in the form of the game win or lose imaging 127′ in the lower portion imaging below the SOC. Clearly, the first collectible imaging 126′ is associated with the second collectible imaging indication 126. Thus. In FIG. 3, the intact ticket 125 upper layer can be seen together with its associated lower layer 125′ with the lower portion imaging first collectible imaging 126′ effectively hidden from view until the ticket is purchased and played.

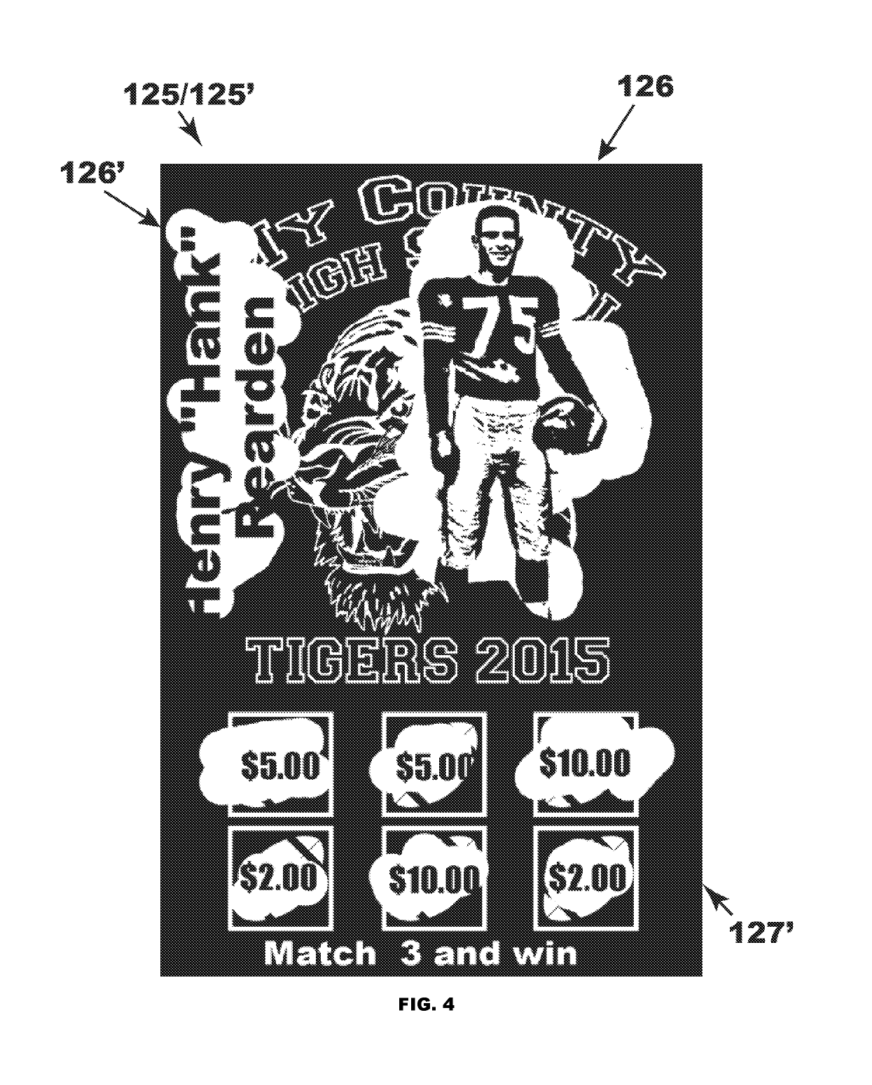

FIG. 4 illustrates a partial SOC removal of the upper portion second collectible imaging in the form of the school mascot 126, revealing a portion of the lower reveal feature in the form of the first collectible team player imaging 126′ as the overprint upper portion imaging and SOC are being removed. Also, as illustrated in FIG. 4, the revealed gaming portion 127′ (the first variable indicia of the lower imaging portion) is separate from the first collectible image 126′. In this embodiment, where the first and second collectible imaging are thematically associated, the hidden collector image of this embodiment requires much less precise registration between the upper portion second collectible imaging and the lower portion first collectible imaging than if the first and second collectible imaging were to be visually associated.

In another embodiment as shown in a version of the ticket 125 of FIG. 1, a perforation or indentation 128 may be added to the ticket 125, thereby separating the second collectible imaging 129 at the top of the upper portion imaging from the gaming portion 130 of the ticket. The perforation or indention 128 allows for any winning gaming portion 130 to be redeemed with the consumer still able to keep the collectible portion 129. The winning game portion 130 could, and in game play ideally should include any logistical information printed on the back of the ticket (e.g., inventory barcode) that may be necessary for validation and redemption of any winning prize(s). The logistical information on the back of the ticket preferably is aligned with the gaming portion 130 at the bottom of the ticket, so that the consumer playing the ticket can keep the collectible imaging at the top of the ticket.

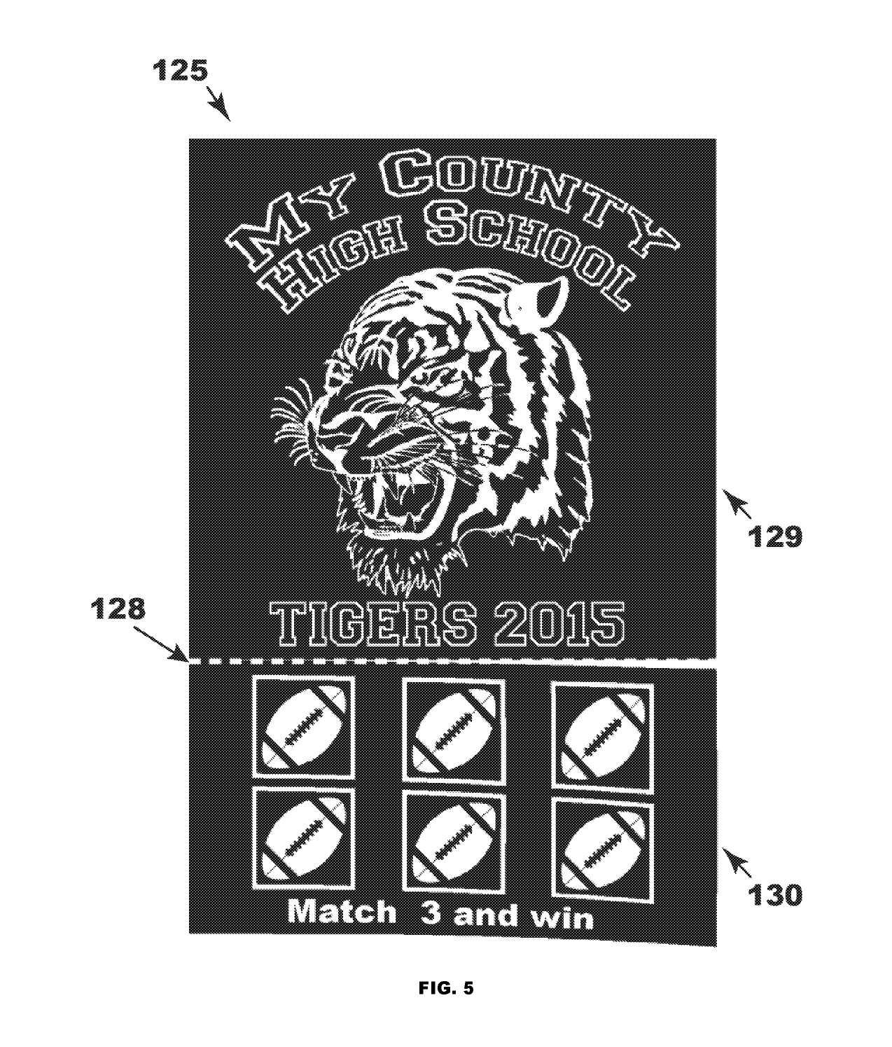

Of course, as would be apparent to one familiar with this art in view of this disclosure, the ticket of FIGS. 1 through 5 depicting a local high school football team and player is only one embodiment of collectible tickets with the first collectible imaging hidden under the SOC of unsold tickets. Other embodiments could include collectible short stories, recipes, coupons, etc. The significant concept is that the collectible portion is hidden from view with all unsold tickets due to the SOC overprint. Thus, only after the ticket is purchased and the SOC is removed does the consumer gain any knowledge of the first collectible imaging in the lower portion imaging, thereby eliminating consumer “cherry picking” of unsold tickets.

An additional embodiment is where at least a part of the lower portion imaging comprises a coupon. An example of this embodiment is where the overprint upper portion imaging includes a theme for the collection, such as automobiles, featuring “Muscle Cars.” The overprint upper portion imaging may then have a second collectible portion imaging, say Chevrolet, and the particular collectible model of Chevrolet cars, may be a part of the lower portion imaging that could include as the first collectible imaging be a “Corvette” or “Camaro SS” for instance. In this case, the coupon that could be a part of the lower portion imaging could be for discount or give away services at a Chevrolet dealer, Chevrolet replacement parts, clothing featuring the Chevrolet logo, etc. Thus, the first and second collectible imaging are associated thematically, and the coupon could also be associated thematically, if desired.

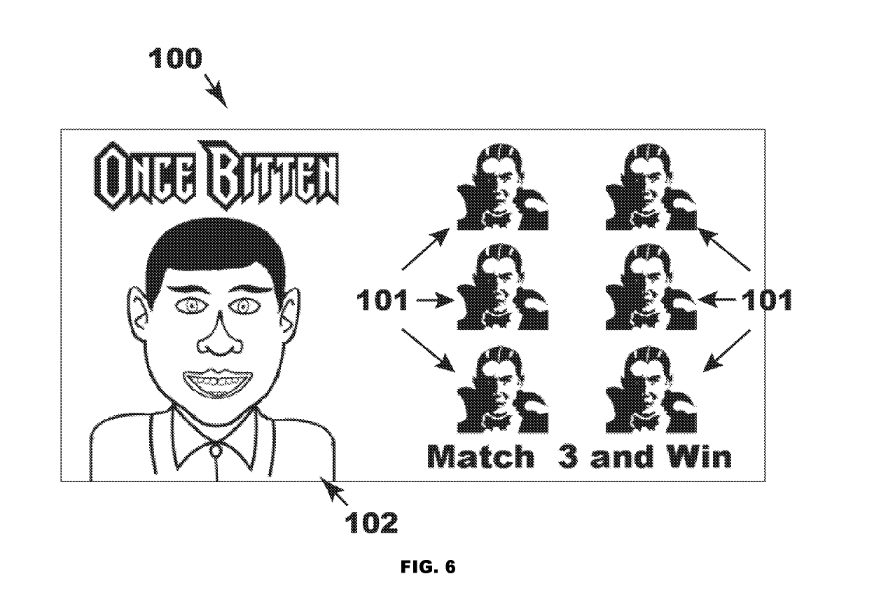

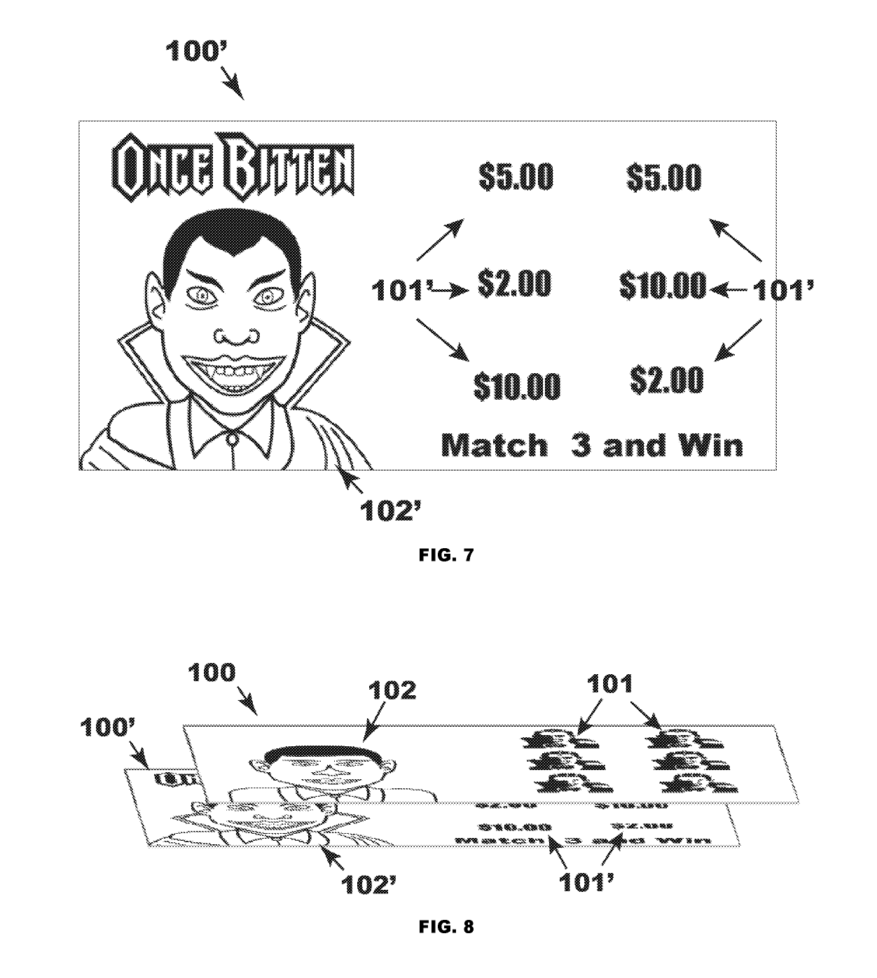

FIG. 6 is a top plan view of another embodiment of an exemplary variable reveal game ticket 100 with its overprint upper layer imaging and SOC intact—i.e., in a pristine, unsold condition. This embodiment may exemplify the popular “Vampire” television series and movies, with a representation of “daytime” young man 102 as the second collectible imaging of the overprint upper portion imaging of the ticket over the SOC, hiding a vampire 102′ shown in FIG. 7 as the first collectible imaging of the lower portion imaging of the ticket. As illustrated in FIG. 6, in the ticket 100, the six “Match 3 and Win” game play overprints 101 are a traditional instant ticket implementation where removal of the SOC simply discloses the game play first variable indicia that are not necessarily synchronized or associated with the overprint image including the second collectible imaging 102. Nevertheless, the embodiment of the ticket 100 also includes a variable reveal feature 102 that is not part of the actual game play—i.e., features 102 and 102′ do not influence the game outcome, but are imaged for amusement and collectible purposes only. While the upper (i.e., imaged on top of the SOC) reveal image 102 of FIG. 6 is illustrated as a line drawing of a young man, it is understood that this feature would be comprised of digitally imaged process color or spot color(s) and can vary from ticket-to-ticket illustrating other images (e.g., young woman, old man, old woman, or other second collectible imaging), or in some embodiments the second collectible imaging can remain essentially the same from ticket-to-ticket (as in the embodiments of the tickets shown in FIGS. 1 through 5).

FIG. 7 illustrates a top plan view of the ticket 100 of FIG. 1 with all of its SOC removed as shown as 100′, revealing the typical win or lose first variable indicia 101′ of a standard instant ticket, as well as the process color variable reveal digital first collectible imaging 102′. Notice that the upper reveal image 102 changes from a young man 102 (FIG. 6—i.e., above the SOC) to a vampire 102′ (FIG. 7) in the lower portion image (i.e., beneath the SOC). This is an example of both the visual and thematic association of the second collectible imaging 102 of the upper portion imaging and the first collectible imaging 102′ of the lower portion imaging mentioned above. By imaging both the upper and lower reveal features having the respective second and first collectible imaging with the same digitally imaged process color or spot color(s) printing techniques, the effect that the consumer visually perceives is a “dissolve” from the upper feature 102 to the lower feature 102′ as he or she gradually removes the SOC, as shown in FIG. 9, where the SOC is partially removed.

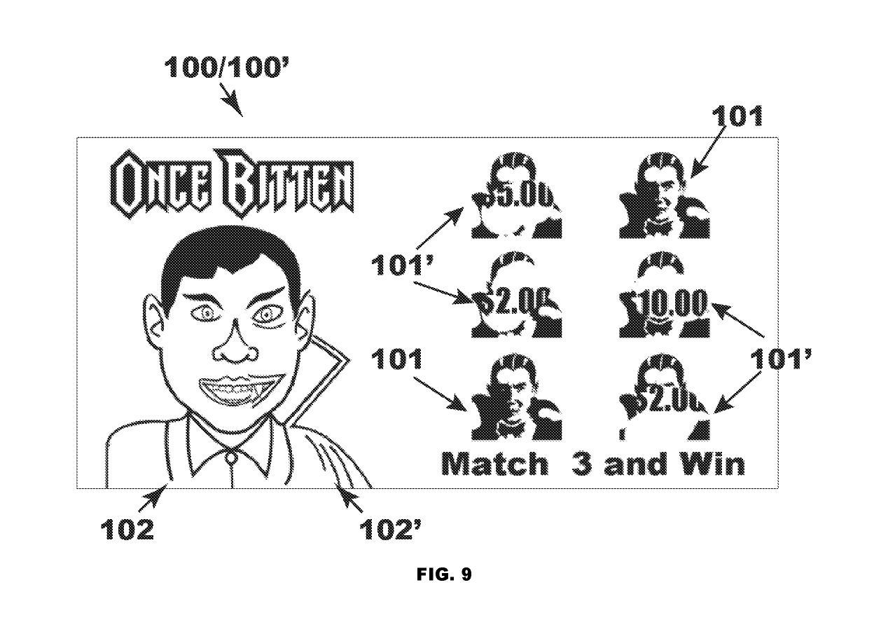

For the dissolve effect to be perceived correctly, both the upper and lower features must be substantially aligned with each other. FIG. 8 is an exploded isometric top front view of the embodiment of the ticket 100 of FIGS. 6 and 7 with intact overprint upper portion imaging and its visually associated lower portion imaging 100′ having the second collectible imaging that is the upper reveal feature 102 substantially aligned with its corresponding lower reveal feature 102′ comprising the first collectible imaging of the lower imaging portion of the ticket. Thus, for a reveal to effectively dissolve from an upper feature 102 to a lower feature 102′, registration between the upper and lower layers is critical. In a preferred embodiment, the registration between the upper feature 102 and the lower feature 102′ should be within plus-or-minus 0.01 inch (0.254 mm). With typical instant ticket presses with fixed plate overprint features, maintaining ±0.01 inch tolerance between the upper feature 102 and the lower feature 102′ would be problematic at best. However, with the use of digital imagers utilizing process colors in this embodiment, the upper and lower imagers can readily maintain this level of registration. It should be noted that with traditional overprints 101 and instant ticket variable indicia 101′ indicative of win or lose in game play, resolution requirements are substantially relaxed and are typically less precise by an order of magnitude or more. This is because traditional fixed plate printing presses are large in size with extremely long paper paths—e.g., 6,000 linear feet (≈1,829 meters). These long paper paths cause the paper to alter its shape as it is heated, cooled, and pulled through the press. Coupled with the problems associated with maintaining mechanical registration from unit to unit within the press line, it can be readily understood how maintaining the desired level of precise registration for a visual dissolve effect would be problematic utilizing traditional (fixed plate) presses.

FIG. 9 illustrates a partial SOC removal of the second collectible imaging or reveal feature 102 of the overprint upper portion imaging, emphasizing a portion of the first collectible imaging or reveal feature 102′ of the lower portion imaging. As illustrated in FIG. 9, the dissolve effect from the visual association of the young man image 102 to the vampire 102′ becomes apparent as the SOC is gradually removed. Also notice in FIG. 9 that partial upper portion imaging and SOC removal with the traditional overprints 101 and the lower portion variable indicia 101′ results in no dissolve effect, since there is no visual or thematic association between them, unlike the visual and thematic association of the overprint upper portion imaging 102 and the lower portion digital imaging 102′. Thus, the essential concept is that the upper and lower reveal features corresponding respectively to the second and first collectible imaging are two full sets of high resolution digitally imaged graphics on the ticket, where the transition reveal graphic (i.e., the lower graphic) is revealed by rubbing off the primary (i.e., upper) graphic printed on top of the SOC. In the embodiments of visually associated dissolve effects between the second and first collectible imaging, registration between the upper and lower reveal features is critical.

All of the previous embodiments utilize a variable reveal display with first and second collectible imaging as a separate feature from the actual game play of an instant lottery ticket or other game ticket. The variable imaging, particularly including collectible imaging elements enables the non-gaming reveals to differ from ticket-to-ticket. These non-gaming reveal-embodiments thereby add value to the instant gaming experience by adding additional play elements that can vary over a large range of tickets. These same reveal features (e.g., dissolve, collectible imaging, etc.) may be incorporated directly into game play where the reveal function outcome influences the prize won (e.g., a ticket with a dissolve reveal that turns a person into a vampire doubles the prize won). There are embodiments where creating a digitally imaged full color or spot color reveal or collectible imaging via SOC removal can directly enhance existing game play.

There are other embodiments of variable reveal features that are an integral part of instant game play dynamics. For example, the overprint upper portion imaging with or without the second collectible imaging over the SOC can vary from ticket-to-ticket with the associated lower portion imaging with its variable first collectible imaging or reveal imaging varying in the degree of registration and alignment with the overprint, while these overprint imaging or second variable indicia still adhere to a common game theme. With this type of variable reveal feature game, ticket variety is achieved including the actual play mechanic (namely, the methodology of the game, such as document or ticket layout, rules, etc.) without necessarily influencing the prize fund.

In other embodiments of the invention, the collectible imaging, and in particular, the first collectible imaging of the lower portion imaging may be present with the lower portion imaging including the first variable indicia, where the first variable indicia comprises one or more win or lose gaming imaging representing game play, wherein the collectible imaging is a part of the game play. For example, the lower portion variable imaging may have matching indicia that represent a value comprising a prize, such that matching indicia of the lower portion represent a game win of the prize pursuant to game rules in the game play.

Whether or not the collectible imaging affects game play when the security document with the SOC, the collectible imaging adds considerable value to consumers who are purchasers and sellers of the document, since the collectible aspect of the document is itself of interest and creates sales of such documents.

There are other variations of the disclosed embodiments that would be apparent to anyone skilled in the art in view of this disclosure.

What is claimed is:

1. A security-enhanced document with collectible imaging, the document comprising:
a substrate;
at least one lower portion imaging with graphic imaging and with or without first variable indicia, the lower portion imaging directly or indirectly digitally imaged on the substrate, the lower portion comprising first collectible digital imaging;
at least one release coat applied over the first collectible imaging;
at least one scratch-off-coating layer applied over the release coat to maintain the first collectible imaging of the lower portion unreadable until removal of the scratch-off-coating; and
at least one overprint upper portion with or without second variable indicia and with second collectible digital imaging associated with the lower portion first collectible imaging with respect to a visual or thematic aspect of the first collectible imaging.

2. The document as in claim 1, wherein the imaging of the upper and lower portions is comprised of process colors.

3. The document as in claim 1, wherein the imaging of the upper and lower portions is comprised of digitally imaged spot colors.

4. The document as in claim 1, wherein at least a part of the lower portion imaging comprises a coupon.

5. The document as in claim 1, wherein the document is a scratch-off game piece, and wherein the lower portion imaging includes the first variable indicia, the first variable indicia comprising one or more win or lose gaming imaging representing game play, the release coat, scratch-off coating and the overprint applied over both the first collectible imaging and the gaming imaging.

6. The document as in claim 5, wherein areas of the document containing the gaming imaging and the second collectible imaging are separable by a perforation or indention in the document.

7. The document as in claim 5, wherein the document optionally includes variable logistical information on a back surface of the document optionally required for validation and redemption of a winning game piece.

8. The document as in claim 5, wherein the collectible imaging is independent of the game play.

9. The document as in claim 5, wherein the collectible imaging is a part of the game play.

10. The document as in claim 5, wherein the lower portion variable imaging may have matching indicia that represent a value comprising a prize, such that matching indicia of the lower portion represent a game win of the prize pursuant to game rules in the game play.
